(19) United States
(12) Patent Application Publication
(10) Pub. No.: US 2019/0054374 A1
(43) Pub. Date: Feb. 21, 2019

(54) DIRECTIONAL HAPTIC VEST SYSTEM AND METHOD

(71) Applicant: Ivan Pesante, Orlando, FL (US)

(72) Inventor: Ivan Pesante, Orlando, FL (US)

(21) Appl. No.: 16/104,113

(22) Filed: Aug. 16, 2018

Related U.S. Application Data
(60) Provisional application No. 62/547,077, filed on Aug. 17, 2017.

(51) Int. Cl. A63F 13/285; G06F 3/01; A63F 13/31

(52) U.S. Cl. CPC A63F 13/285; G06F 3/016; A63F 2300/8076; A63F 2300/302; A63F 2300/406; A63F 13/31

(57) ABSTRACT

A device including a wearable accessory, a plurality of pads, a plurality of haptic sensors, a plurality of speakers, an internal wire harness, a wireless transceiver, and a power supply. The device is useful for supplying haptic feedback by detecting point of impact on the body in a virtual game, and then transferring the force and sound from the wearable accessory to the wearer in a specific location on the wearable accessory.

### CROSS-REFERENCE TO RELATED APPLICATION(S)

The present application is related to and claims priority to U.S. Provisional Patent Application No. 62/547,077 filed Aug. 17, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of haptic feedback devices of existing art and more specifically relates to wearable haptic feedback devices.

### Related Art

People who play video games often enjoy being fully immersed in the game. While playing shooting games, part of the immersion is identifying where a player is being shot/tagged. Discovering an opponent's position and making swift decisions may be an important aspect of playing the game. It may be difficult for some people to identify where he/she is being tagged from within the game. Haptic, or kinesthetic, communication recreates the sense of touch by applying forces, vibrations, or motions to the user. Haptic devices may incorporate tactile sensors that measure forces exerted by the user on the interface. A suitable solution is desired.

U.S. Pub. No. 2012/0190460 to Cecil Sessions relates to a vibrating gaming vest. The described vibrating gaming vest includes a video game console accessory providing a vest with sensory feedback rumblers at various positions on a vest. The game console may now provide sensory feedback to the game player by coordinating what occurs visually in the game with a physical sensation experienced by the game player. The rumblers are positioned against the gamer's torso to provide dynamic sensations to increase realism experienced during game play. Each rumbler is independently controlled. An optional feature is the availability of various skins to alter the appearance of the device and to match a particular theme of the game played.

### SUMMARY OF THE INVENTION

In view of the foregoing disadvantages inherent in the known wearable haptic feedback device art, the present disclosure provides a novel directional haptic vest system. The general purpose of the present disclosure, which will be described subsequently in greater detail, is to provide an effective and efficient directional haptic vest system.

A device is disclosed herein. The device includes a wearable accessory, a plurality of pads, a plurality of haptic sensors, a plurality of speakers, an internal wire harness, a wireless transceiver, and a power supply. Further, the device communicates and charges simultaneously while plugged in with a USB wire as well if desired by the user. The wearable accessory may have a front-chest-portion with a vertical hook-and-loop opening, a rear-back-portion adjacent to the front-chest-portion, a left shoulder upper-portion, a right shoulder upper-portion, a right-side-strap, and a left-side-strap. A plurality of pads may be fixedly attached to the body of the wearable accessory on the front-chest-portion, the rear-back-portion, the left shoulder upper-portion, and the right shoulder upper-portion. A plurality of haptic sensors may be internally connected to the plurality of pads on the front-chest-portion, the rear-back-portion, the left shoulder upper-portion, and the right shoulder upper-portion.

A plurality of speakers may be internally connected to the plurality of pads on the front-chest-portion, the rear-back-portion, the left shoulder upper-portion, and the right shoulder upper-portion. An internal wire harness may be used to connect the plurality of haptic sensors and the plurality of speakers to the plurality of pads on the front-chest-portion, the rear-back-portion, the left shoulder upper-portion, and the right shoulder. A wireless transceiver for wireless connection to a game console may be fixedly attached to the body of the wearable accessory; and a power supply may be connected to the internal wire harness to supply power to the plurality of haptic sensors and the plurality of speakers on the front-chest-portion, the rear-back-portion, the left shoulder upper-portion, and the right shoulder upper-portion. The wearable accessory is worn on an upper-torso and may supply haptic feedback by detecting point of impact on the body in a virtual game, and then may transfer the force and sound from the wearable accessory to the wearer in a specific location on the wearable accessory.

According to another embodiment, a method of using the haptic device is also disclosed herein. The method of using the haptic device includes providing a haptic feedback device, equipping the haptic feedback device to a body of a user, syncing the haptic feedback device to a game console, playing a supported video game using the haptic feedback device, removing the haptic feedback device, and attaching a set of headphones to the haptic feedback device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a directional haptic vest system, constructed and operative according to the teachings of the present disclosure.

FIG. 1 is a front and rear view of the device during an ‘in-use’ condition, according to an embodiment of the disclosure.

FIG. 2 is a front view of the device of FIG. 1, according to an embodiment of the present disclosure.

FIG. 3 is a front and rear view of the device of FIG. 1, according to an embodiment of the present disclosure.

FIG. 4 is a perspective view of the device of FIG. 1, according to an embodiment of the present disclosure.

FIG. 5 is a flow diagram illustrating a method of using the haptic device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a wearable haptic feedback device and more particularly to a directional haptic vest system as used to improve the virtual gaming experience by allowing gamers to make quick efficient decisions on where damage is being taken by their virtual game character.

Generally, virtual reality games are a game experience that takes place in a simulated environment that incorporates auditory, visual, haptic, and other sensory feedback. Current virtual reality technology most commonly uses virtual reality headsets or multi-projected environments, sometimes in combination with physical environments or props, to generate realistic images, sounds and other sensations that simulate a user's physical presence in a virtual or imaginary environment. A person using virtual reality equipment is able to “look around” the artificial world, move around in it, and interact with virtual features or items.

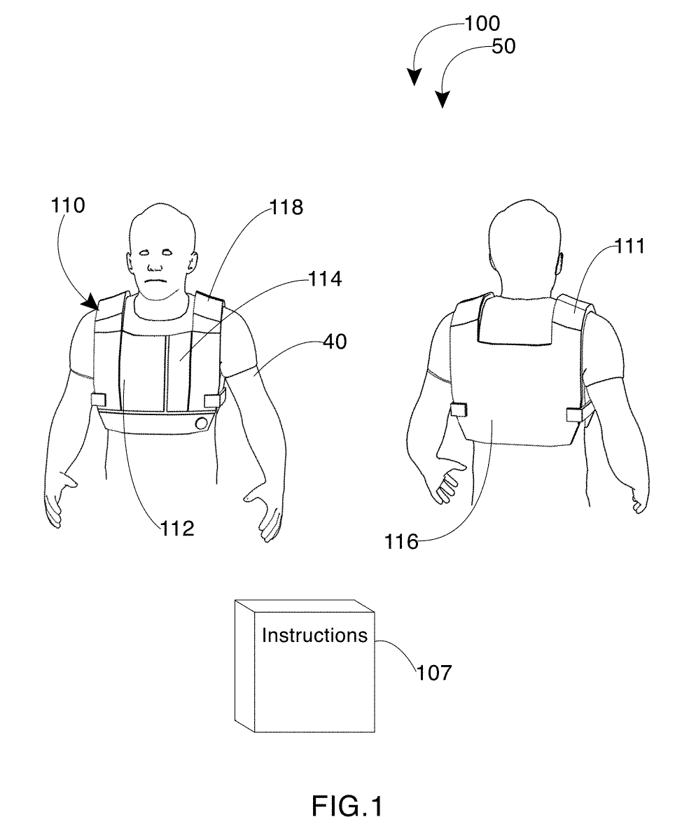

Referring now more specifically to the drawings by numerals of reference, there is shown in FIGS. 1-4, various views of a device 100. FIG. 1 shows a device 100 during an ‘in-use’ condition 50, according to an embodiment of the present disclosure. Here, the device 100 may be beneficial for use by a user 40 to detect point of impact on the body in a virtual game and then transfer the force and sound of that impact to the user. As illustrated, the device 100 may include a wearable accessory 110, a plurality of pads 120, a plurality of haptic sensors 130, a plurality of speakers 140, an internal wire harness 150, a wireless transceiver 160, and a power supply 170.

The wearable accessory may have a front-chest-portion 112 with a vertical hook-and-loop opening 114, a rear-back-portion 116 adjacent to the front-chest-portion 112, a left shoulder upper-portion 118, a right shoulder upper-portion 111, a right-side-strap 113, and a left-side-strap 115. A plurality of pads 120 may be fixedly attached to the body of the wearable accessory 110 on the front-chest-portion 112, the rear-back-portion 116, the left shoulder upper-portion 118, and the right shoulder upper-portion 111. A plurality of haptic sensors 130 may be internally connected to the plurality of pads 120 on the front-chest-portion 112, the rear-back-portion 116, the left shoulder upper-portion 118, and the right shoulder upper-portion 111, wherein the plurality of haptic sensors 130 are omni-directional and configured to simulate the directional-force of being struck by an object on different levels.

A plurality of speakers 140 are internally connected to the plurality of pads 120 on the front-chest-portion 112, the rear-back-portion 116, the left shoulder upper-portion 118, and the right shoulder upper-portion 111. An internal wire harness 150 may be used for connecting the plurality of haptic sensors 130 and the plurality of speakers 140 to the plurality of pads 120 on the front-chest-portion 112, the rear-back-portion 116, the left shoulder upper-portion 118, and the right shoulder upper-portion 111. A wireless transceiver 160 may be included for wireless connection to a game console, and may be fixedly attached to the body of the wearable accessory 110, wherein the wireless transceiver 160 exchanges data using short-wavelength ultra-high-frequency radio waves for connecting wirelessly to a game console; and a power supply 170 connected to the internal wire harness 150 to supply power to the plurality of haptic sensors 130 and the plurality of speakers 140 on the front-chest-portion 112, the rear-back-portion 116, the left shoulder upper-portion 118, and the right shoulder upper-portion 111. The wearable accessory 110 is worn on an upper-torso and supplies haptic feedback by detecting point of impact on the body in a virtual game and transfers the force and sound from the wearable accessory to the wearer in a specific location on the wearable accessory 110.

According to one embodiment, the device 100 may be arranged as a kit 105. In particular, the device 100 may further include a set of instructions 107. The instructions 107 may detail functional relationships in relation to the structure of the device 100 such that the device 100 can be used, maintained, or the like, in a preferred manner.

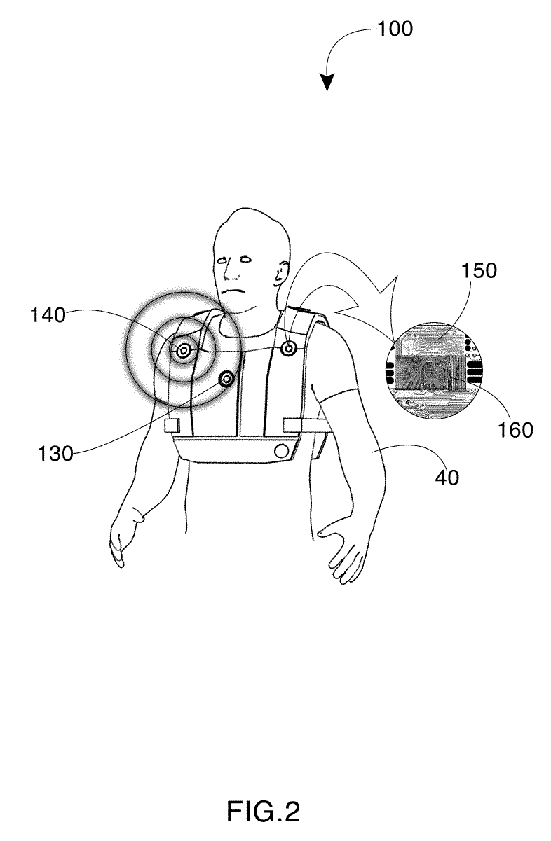

FIG. 2 shows the device 100 of FIG. 1, according to an embodiment of the present disclosure. As above, the device 100 may include a wearable accessory 110, a plurality of pads 120, a plurality of haptic sensors 130, a plurality of speakers 140, an internal wire harness 150, a wireless transceiver 160, and a power supply 170. The wearable accessory 110 may include a front-chest-portion 112 with a vertical hook-and-loop opening 114, a rear-back-portion 116 adjacent to the front-chest-portion 112, a left shoulder upper-portion 118, a right shoulder upper-portion 111, a right-side-strap 113, and a left-side-strap 115. A plurality of pads 120 may be fixedly attached to the body of the wearable accessory 110 on the front-chest-portion 112, the rear-back-portion 116, the left shoulder upper-portion 118, and the right shoulder upper-portion 111. A plurality of haptic sensors 130 may be internally connected to the plurality of pads 120 on the front-chest-portion 112, the rear-back-portion 116, the left shoulder upper-portion 118, and the right shoulder upper-portion 111, wherein the plurality of haptic sensors 130 are omni-directional and configured to simulate the directional-force of being struck by an object on different levels.

A plurality of speakers 140 internally connected to the plurality of pads 120 on the front-chest-portion 112, the rear-back-portion 116, the left shoulder upper-portion 118, and the right shoulder upper-portion 111. The plurality of speakers 140 may be configured to change the volume of sound dependent on the severity of an impact. An internal wire harness 150 may be use for connecting the plurality of haptic sensors 130 and the plurality of speakers 140 to the plurality of pads 120 on the front-chest-portion 112, the rear-back-portion 116, the left shoulder upper-portion 118, and the right shoulder upper-portion 111. A wireless transceiver 160 may be included for wireless connection to a game console, and may be fixedly attached to the body of the wearable accessory 110, wherein the wireless transceiver 160 exchanges data using short-wavelength ultra-high-frequency radio waves for connecting wirelessly to a game console; and a power supply 170 connected to the internal wire harness 150 to supply power to the plurality of haptic sensors 130 and the plurality of speakers 140 on the front-chest-portion 112, the rear-back-portion 116, the left shoulder upper-portion 118, and the right shoulder upper-portion 111. The wearable accessory 110 is worn on an upper-torso and supplies haptic feedback by detecting point of impact on the body in a virtual game and transfers the force and sound from the wearable accessory to the wearer in a specific location on the wearable accessory 110.

The plurality of pads 120 may include a plurality of pads 120 fixedly attached to the body of the wearable accessory 110 on the front-chest-portion 112, the rear-back-portion 116, the left shoulder upper-portion 118, and the right shoulder upper-portion 111. The wireless transceiver 160 may be configured to connect to multiple gaming platforms.

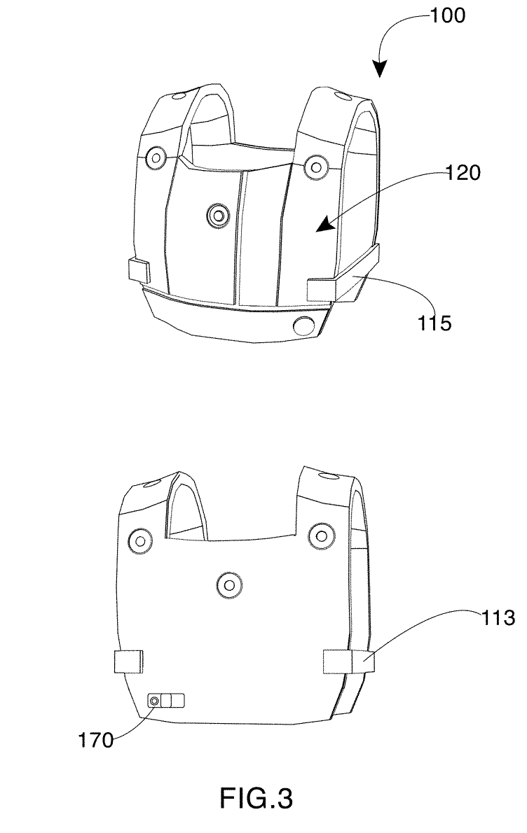

FIG. 3 is a front and rear view of the device 100 of FIG. 1, according to an embodiment of the present disclosure. A plurality of haptic sensors 130 may be internally connected to the plurality of pads 120 on the front-chest-portion 112, the rear-back-portion 116, the left shoulder upper-portion 118, and the right shoulder upper-portion 111, wherein the plurality of haptic sensors 130 are omni-directional and configured to simulate the directional-force of being struck by an object on different levels. A plurality of speakers 140 are internally connected to the plurality of pads 120 on the front-chest-portion 112, the rear-back-portion 116, the left shoulder upper-portion 118, and the right shoulder upper-portion 111. The plurality of haptic sensors 130 may be omni-directional configured to simulate the directional-force of being struck by an object on different levels by emitting two short bursts when a wearer is struck from an upper plane, one long burst when a wearer is struck from a level plane, and one short burst when a wearer is struck from a lower plane. The plurality of haptic sensors 130 mimics the impact position on the wearable accessory where the virtual character is struck in game. The plurality of haptic sensors 130 may be configured to change intensity of vibration dependent on severity of an impact and may be configured to register multiple impacts simultaneously. Furthermore, in the event of virtual character death, a distinct sensory function will emanate from the device, as well as a separate distinct sensory function for indicating a headshot on a virtual character.

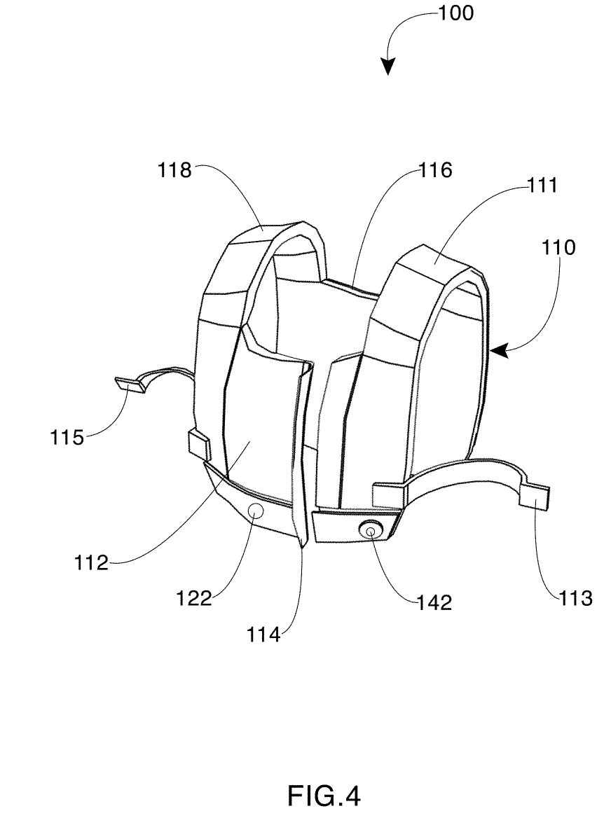

FIG. 4 is a perspective view of the device 100 of FIG. 1, according to an embodiment of the present disclosure. The wearable accessory 110 may include a front-chest-portion 112 with a vertical hook-and-loop opening 114, a rear-back-portion 116 adjacent to the front-chest-portion 112, a left shoulder upper-portion 118, a right shoulder upper-portion 111, a right-side-strap 113, and a left-side-strap 115. The wearable accessory 110 may include a headset jack 142 allowing an audio headset to be used in conjunction with the wearable accessory 110. The wearable accessory 110 may also include a mute button 122 integrated into the body of the wearable accessory 110 configured to halt functions of the plurality of haptic sensors 130 and alternately the plurality of speakers 140 during gameplay.

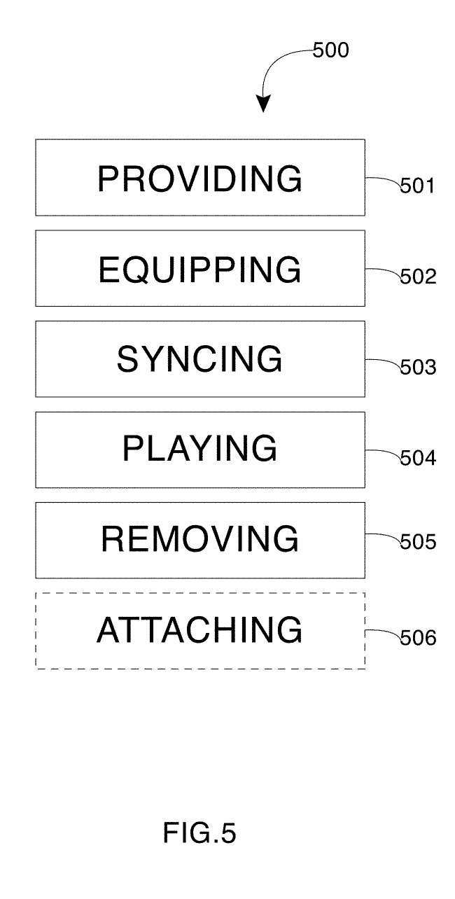

FIG. 5 is a flow diagram illustrating a method for using a haptic feedback device 500, according to an embodiment of the present disclosure. In particular, the method for using a haptic feedback device 500 may include one or more components or features of the device 100 as described above. As illustrated, the method for using a haptic feedback device 500 may include the steps of: step one 501, providing a haptic feedback device; step two 502, equipping the haptic feedback device to a body of a user; step three 503, syncing the haptic feedback device to a game console; step four 504, playing a supported video game using the haptic feedback device; step five 505, removing the haptic feedback device; and step six 506, attaching a set of headphones to the haptic feedback device.

It should be noted that step 506 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using the haptic device, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device, the device comprising:
a wearable accessory having a front-chest-portion with a vertical hook-and-loop opening, a rear-back-portion adjacent to the front-chest-portion, a left shoulder upper-portion, a right shoulder upper-portion, a right-side-strap, and a left-side-strap;
a plurality of pads fixedly attached to the body of the wearable accessory on the front-chest-portion, the rear-back-portion, the left shoulder upper-portion, and the right shoulder upper-portion;
a plurality of haptic sensors internally connected to the plurality of pads on the front-chest-portion, the rear-back-portion, the left shoulder upper-portion, and the right shoulder upper-portion;
a plurality of speakers internally connected to the plurality of pads on the front-chest-portion, the rear-back-portion, the left shoulder upper-portion, and the right shoulder upper-portion;
an internal wire harness connecting the plurality of haptic sensors and the plurality of speakers to the plurality of pads on the front-chest-portion, the rear-back-portion, the left shoulder upper-portion, and the right shoulder upper-portion;
a wireless transceiver for wireless connection to a game console fixedly attached to the body of the wearable accessory; and
a power supply connected to the internal wire harness to supply power to the plurality of haptic sensors and the plurality of speakers on the front-chest-portion, the rear-back-portion, the left shoulder upper-portion, and the right shoulder upper-portion;
wherein the wearable accessory is worn on an upper-torso and supplies haptic feedback by detecting point of impact on the body in a virtual game and transfers the force and sound from the wearable accessory to the wearer in a specific location on the wearable accessory.

2. The device of claim 1, wherein the wireless transceiver exchanges data using short-wavelength ultra-high-frequency radio waves for connecting wirelessly to a game console.

3. The device of claim 1, wherein the wearable accessory includes a headset jack configured to support an audio headset.

4. The device of claim 1, wherein the wearable accessory includes a mute button integrated into the body of the wearable accessory configured to halt functions of the plurality of haptic sensors and the plurality of speakers.

5. The device of claim 1, wherein the plurality of haptic sensors are omni-directional and configured to simulate the directional-force of being struck by an object on different levels.

6. The device of claim 5, wherein the plurality of haptic sensors emits two short bursts when a wearer is struck from an upper plane.

7. The device of claim 5, wherein the plurality of haptic sensors emits one long burst when a wearer is struck from a level plane.

8. The device of claim 5, wherein the plurality of haptic sensors emits one short burst when a wearer is struck from a lower plane.

9. The device of claim 5, wherein the plurality of haptic sensors mimics the impact position on the wearable accessory where the virtual character is struck.

10. The device of claim 2, wherein the wireless transceiver is configured to connect to multiple gaming platforms.

11. The device of claim 1, wherein the wearable accessory is configured to adapt to a plurality of gaming genres.

12. The device of claim 1, wherein the plurality of haptic sensors are configured to change intensity of vibration dependent on severity of an impact.

13. The device of claim 1, wherein the plurality of speakers are configured to change volume of sound dependent on severity of an impact.

14. The device of claim 1, wherein the plurality of haptic sensors are configured to register multiple impacts simultaneously.

15. The device of claim 1, wherein the power supply is configured to be rechargeable.

16. The device of claim 1, wherein the wearable accessory is configured to be adjustable for receiving multiple body types.

17. A haptic device, the device comprising:
a wearable accessory having a front-chest-portion with a vertical hook-and-loop opening, a rear-back-portion adjacent to the front-chest-portion, a left shoulder upper-portion, a right shoulder upper-portion, a right-side-strap, and a left-side-strap;
a plurality of pads fixedly attached to the body of the wearable accessory on the front-chest-portion, the rear-back-portion, the left shoulder upper-portion, and the right shoulder upper-portion;
a plurality of haptic sensors internally connected to the plurality of pads on the front-chest-portion, the rear-back-portion, the left shoulder upper-portion, and the right shoulder upper-portion, wherein the plurality of haptic sensors are omni-directional configured to simulate the directional-force of being struck by an object on different levels;
a plurality of speakers internally connected to the plurality of pads on the front-chest-portion, the rear-back-portion, the left shoulder upper-portion, and the right shoulder upper-portion;
an internal wire harness connecting the plurality of haptic sensors and the plurality of speakers to the plurality of pads on the front-chest-portion, the rear-back-portion, the left shoulder upper-portion, and the right shoulder upper-portion;
a wireless transceiver for wireless connection to a game console fixedly attached to the body of the wearable accessory, wherein the wireless transceiver exchanges data using short-wavelength ultra-high-frequency radio waves for connecting wirelessly to a game console; and
a power supply connected to the internal wire harness to supply power to the plurality of haptic sensors and the plurality of speakers on the front-chest-portion, the rear-back-portion, the left shoulder upper-portion, and the right shoulder upper-portion;
wherein the wearable accessory is worn on an upper-torso and supplies haptic feedback by detecting point of impact on the body in a virtual game and transfers the force and sound from the wearable accessory to the wearer in a specific location on the wearable accessory.

18. The haptic device of claim 17, further comprising set of instructions; and
wherein the haptic device is arranged as a kit.

19. A method of using the haptic device, the method comprising the steps of:
providing a haptic feedback device;
equipping the haptic feedback device to a body of a user;
syncing the haptic feedback device to a game console;
playing a supported video game using the haptic feedback device; and
removing the haptic feedback device.

20. The method of claim 19, further comprising the step of:
attaching a set of headphones to the haptic feedback device.
